(19) United States
(12) Patent Application Publication
(10) Pub. No.: US 2018/0294105 A1
(43) Pub. Date: Oct. 11, 2018

(54) CAPACITOR AND METHOD OF MANUFACTURING THE SAME

(71) Applicant: HON HAI PRECISION INDUSTRY CO., LTD., New Taipei (TW)

(72) Inventors: TSUNG-JU WU, New Taipei (TW); HSIN-PEI HSIEH, New Taipei (TW)

(21) Appl. No.: 15/616,825

(22) Filed: Jun. 7, 2017

(30) Foreign Application Priority Data
Apr. 11, 2017 (TW) 106112066

(51) Int. Cl. H01G 9/048; H01G 9/145; H01G 9/008

(52) U.S. Cl. CPC H01G 9/048; H01G 9/008; H01G 9/145

(57) ABSTRACT

A capacitor manufacturing method includes a plurality of conductive sheets, a plurality of first sealing members, an electrolyte solution, and a plurality of supporting members. Each first sealing member is arranged around the edges of each conductive sheet. The conductive sheets are stacked with each other via the plurality of first sealing members. Each two adjacent conductive sheets and at least one of the first sealing members together form a receiving cavity. The electrolyte solution fills each receiving cavity; and the plurality of supporting members are formed in each receiving cavity to support adjacent conductive sheets.

### FIELD

The subject matter herein generally relates to a capacitor and a method of manufacturing the same.

### BACKGROUND

Capacitors have been widely used in noise bypass filters, integral circuits, and oscillation circuits, due to their small sizes, large storage capacities, and high temperature tolerance. However, it's been difficult for conventional capacitors formed by winding metal sheets to achieve large storage capacities.

### BRIEF DESCRIPTION OF THE DRAWINGS

Implementations of the present technology will now be described, by way of example only, with reference to the attached figures.

FIG. 1 is an isometric view of a capacitor in accordance with one exemplary embodiment.

FIG. 2 is an exploded isometric view of portions of the capacitor of FIG. 1.

FIG. 3 is a cross-sectional view taken along line III-III of FIG. 1.

FIG. 4 is an isometric view of a capacitor in accordance with one exemplary embodiment.

FIG. 5 is an isometric view of a capacitor in accordance with one exemplary embodiment.

FIG. 6 is an isometric view of a capacitor in accordance with one exemplary embodiment.

FIG. 7 is a cross-sectional view of a capacitor in accordance with one exemplary embodiment.

FIG. 8 illustrates a flowchart of manufacturing a capacitor in accordance with one exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

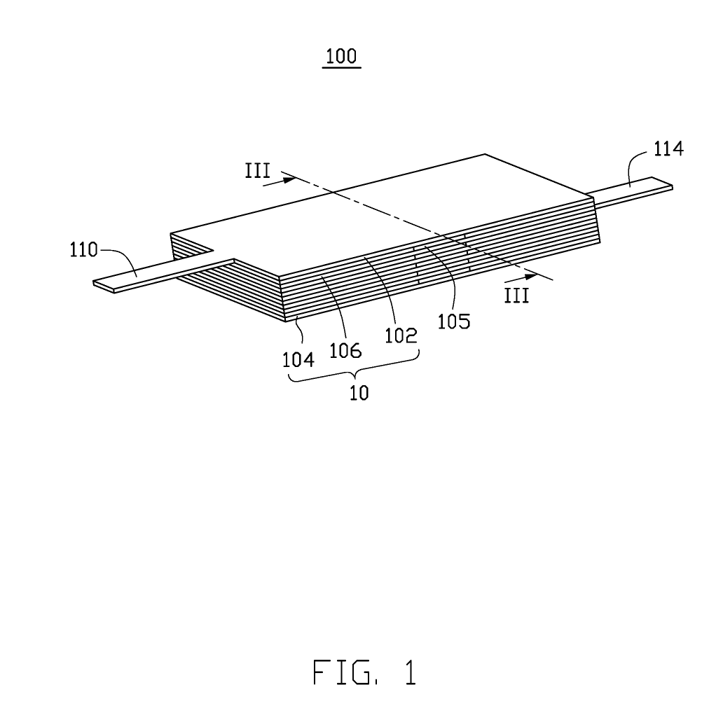

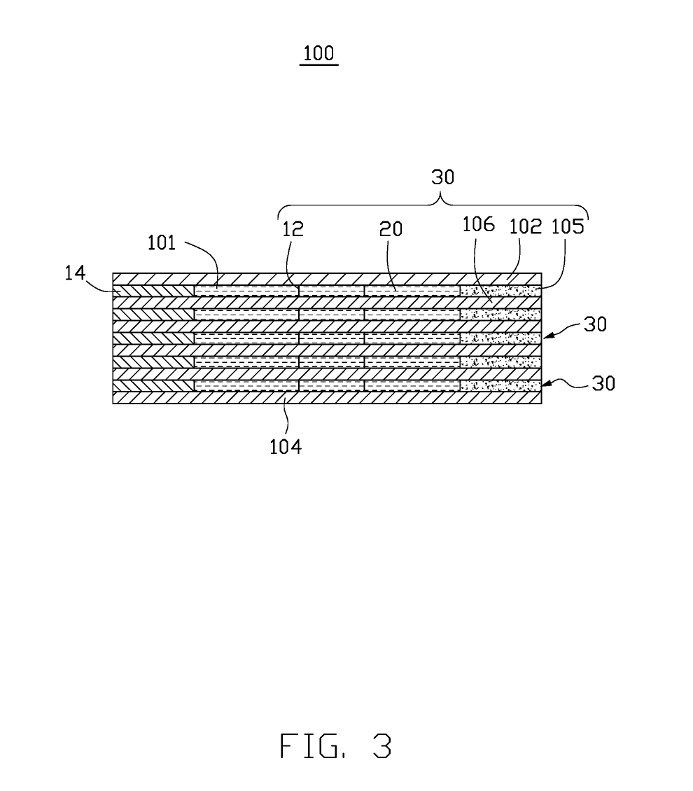

FIGS. 1-3 illustrate a capacitor 100 according to one embodiment. The capacitor 100 includes a plurality of conductive sheets 10 spaced apart and stacked with each other. A plurality of receiving cavities 101 is formed between each two adjacent conductive sheets 10, a plurality of supporting members 12 are formed in each receiving cavity 101, and an electrolyte solution 20 is received in each receiving cavity 101.

The conductive sheets 10 are conductive metal sheets or conductive ceramics sheets. In detail, the plurality of conductive sheets 10 includes a first conductive sheet 102, a second conductive sheet 104, and a plurality of third conductive sheets 106 sandwiched between the first conductive sheet 102 and the second conductive sheet 104. The first conductive sheet 102 and the second conductive sheet 104 are the outermost layers of the capacitor 100. The first conductive sheet 102 has a same shape as the second conductive sheet 104, and both of them has a thickness about 120 to 200 micrometers (i.e., 10̂A-6 meters). The third conductive sheets 106 in the plurality have substantially the same size as each other.

The first conductive sheet 102 includes a first flat plate portion 108 and a first metal electrode 110 formed thereon. The second conductive sheet 104 includes a second flat plate portion 112 and a second metal electrode 114 formed thereon. The first flat plate portion 108 and the second flat plate portion 114 correspond to the third conductive sheets 106. The first metal electrode 110 is able to be formed at one side surface of the first conductive sheet 102 or formed at a surface away from the third conductive sheets 106. In this embodiment, the first metal electrode 110 is integrally formed at a first side of the first conductive sheet 102, and the second metal electrode 114 is integrally formed at a second side of the second conductive sheet 104, the first side and the second side are opposite to each other. The first electrode 110 and the second metal electrode 114 are configured as a positive terminal and a negative terminal respectively.

The third conductive sheets 10 are substantially rectangular with a thickness of about 120 to 200 micrometers. Each of the plurality of third conductive sheets 106 are stacked and spaced apart from each other.

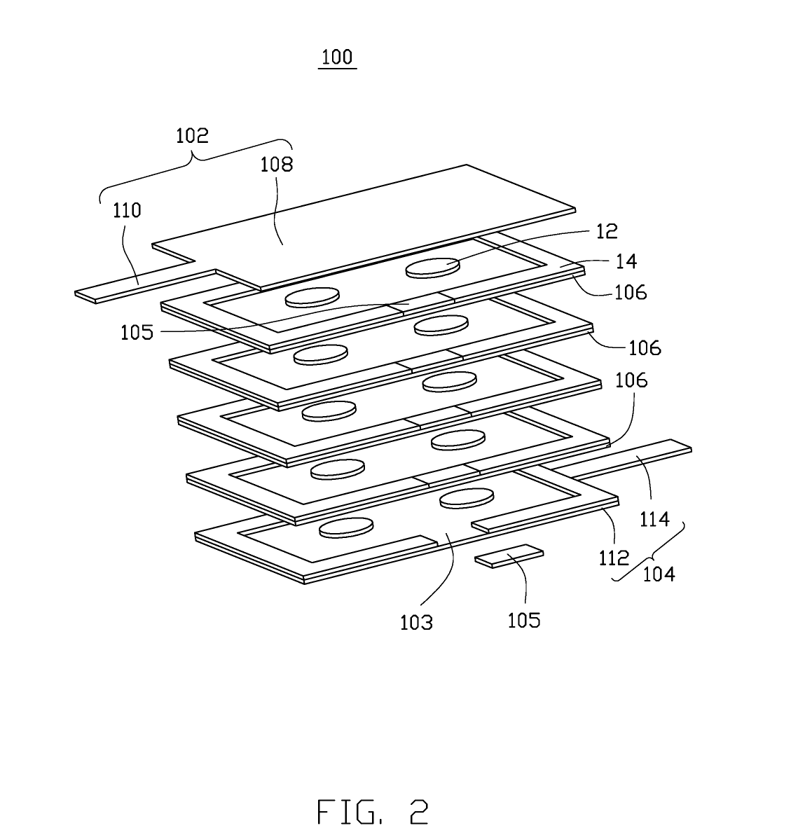

As shown in FIG. 2, the first sealing members 14 are configured to create space between the first conductive sheet 102 and the third conductive sheet 106 immediately below the first conductive sheet 102, to create space between each adjacent pair of the plurality of third conductive sheets 106, and to create space between the second conductive sheet 104 and the third conductive sheet 106 immediately above the third conductive sheet 106. The first sealing members 14 are substantially formed around edges of the first conductive sheet 102, the third conductive sheets 106 and the second conductive sheet 104. As a result, each receiving cavity 101 is formed between each two adjacent conductive sheets 10 and one of the first sealing members 14.

Each first sealing member 14 includes an opening 103. The opening 103 is an entrance of each receiving cavity 101. That is, the electrolyte solution 20 is injected into the receiving cavity 101 through the opening 103. A height of each receiving cavity 101 is determined by a thickness of the first sealing member 14 formed between each two adjacent conductive sheets 10. In this embodiment, the first sealing member 14 is formed by a thermosetting adhesive squeezed into and cured in the receiving cavity 101.

The supporting members 12 are substantially cylinder-shaped and formed on one surface of each conductive sheet 10. The supporting members 12 support each two adjacent conductive sheets 10, to prevent collapse of the receiving cavity 101, and to avoid short circuiting of the capacitor 100. The supporting members 12 in each receiving cavity 101 has substantially the same height. In this embodiment, the height of the supporting member 12 is substantially the same as the thickness of the first sealing member 14. The supporting members 12 are formed by thermosetting adhesive squeezed in and cured. In another embodiment, the supporting members 12 are also can be a globular or an ellipsoid shape. The supporting members 12 support each two adjacent conductive sheets 10, therefore determining a definite height between each two adjacent conductive sheets 10, to prevent the first sealing member 14, that has no definite shape before curing, from skewing.

The electrolyte solution 20 is injected into each receiving cavity 101 through the opening 103. The electrolyte solution 20 may include tetraethylammonium tetrafluoroborate, three ethyl, or methyl ammonium tetrafluoroborate. In other embodiments, the electrolyte solution 20 is gel electrolyte.

The capacitor 100 further includes a plurality of second sealing elements 105. Each second sealing element 105 is configured for sealing each opening 103, to prevent the electrolyte solution 20 from leaking. The second sealing element 105 can also be formed through a thermosetting adhesive and curing process.

When the capacitor 100 is in use, the first metal electrodes 110 and the second metal electrodes 114 are electrically connected to a circuit. Each receiving cavity 101 and the electrolyte solution 20 received in a corresponding receiving cavity 101 together form a capacitor monomer 30, and the electrolyte solution 20 is a conductive pathway of electrons of each capacitor monomer 30. Thereby, the capacitor monomers 30 are electrically connected in series, thus the plurality of capacitor monomers 30 together form a large capacity capacitor 100.

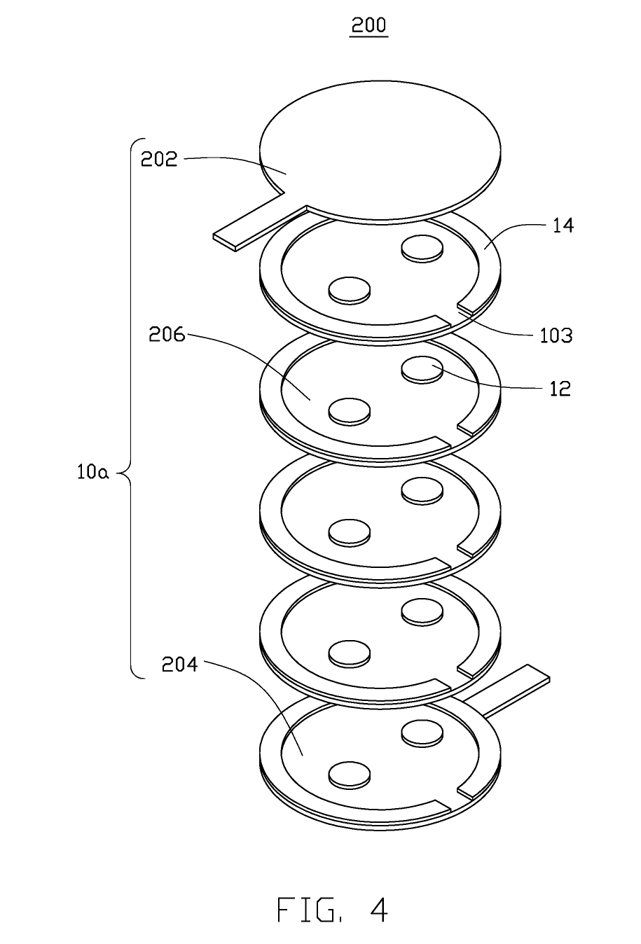

FIG. 4 illustrates a capacitor 200 according to one embodiment. The capacitor 200 in FIG. 4 is similar to the capacitor 100 in FIG. 1. For example, with similar numerals representing similar features in FIG. 1, the capacitor 200 includes a first conductive sheet 202, a second conductive sheet 204, and a plurality of third conductive sheets 206. The first sealing members 14, support members 12 and openings 103 are substantially similar to the first sealing members 14, support members 12 and openings 103, respectively in FIG. 1. It is noted that the second sealing members 105 and electrolyte solution 20 are omitted from FIG. 2 for conceptual clarity, but would otherwise be included as part of the capacitor 200. The difference between the capacitor 200 and the capacitor 100 in FIG. 1 is that the conductive sheets 10a are circular, and the capacitor 200 is substantially cylindrical.

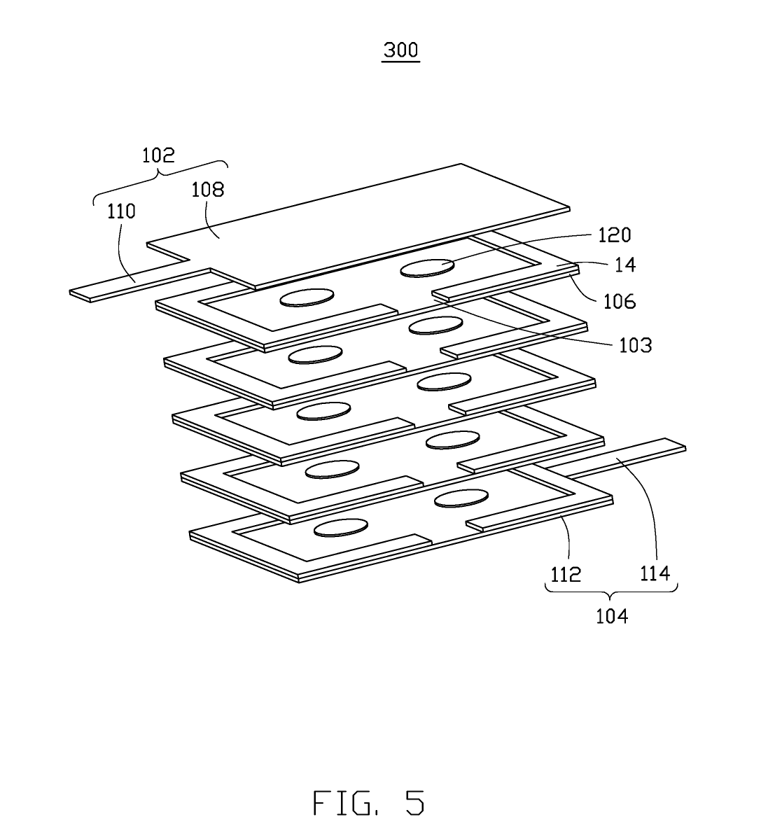

FIG. 5 illustrates a capacitor 300 according to one embodiment. The capacitor 300 in FIG. 5 is similar to the capacitor 100 in FIG. 1. For example, with similar numerals representing similar features in FIG. 1, the capacitor 300 includes a first conductive sheet 102, a second conductive sheet 104, and a plurality of third conductive sheets 106. The first sealing members 14 and openings 103 are substantially similar to the first sealing members 14 and openings 103, respectively, in FIG. 1. It is noted that the second sealing members 105 and electrolyte solution 20 are omitted from FIG. 5 for conceptual clarity, but would otherwise be included as part of the capacitor 300. The difference between the capacitor 300 and the capacitor 100 in FIG. 1 is that the heights of the supporting members 120 in each receiving cavity 101 are shorter than the thickness of the corresponding first sealing member 14, and the supporting members 120 in each receiving cavity 101 ensure that two adjacent conductive sheets 10 are not in contact with each other, thus the capacitor 300 will not short-circuit.

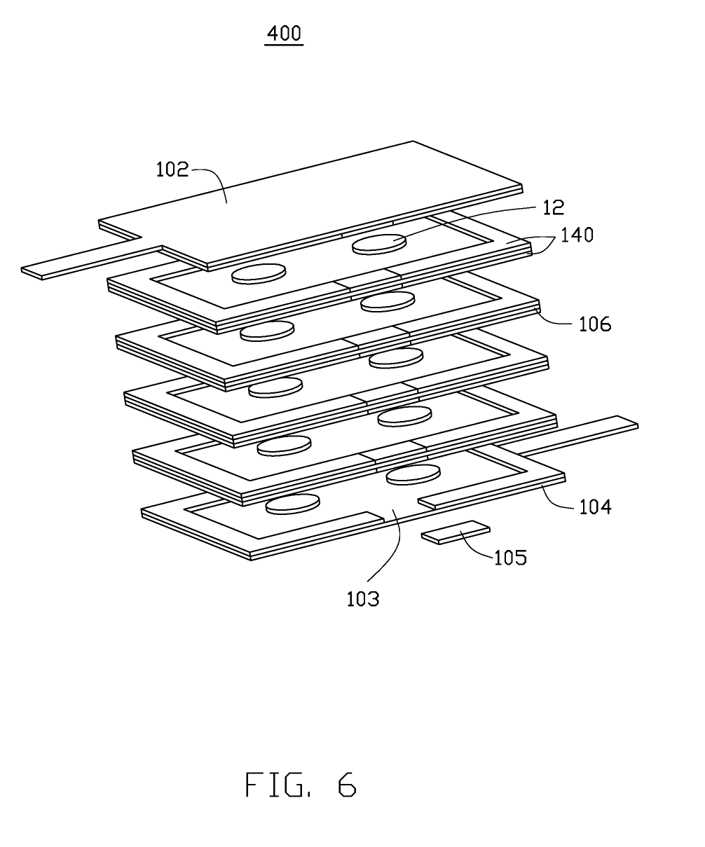

FIG. 6 illustrates a capacitor 400 according to one embodiment. The capacitor 400 in FIG. 6 is similar to the capacitor 100 in FIG. 2. For example, with similar numerals representing similar features in FIG. 1, the capacitor 400 includes a first conductive sheet 102, a second conductive sheet 104, and a plurality of third conductive sheets 106. The support members 12 and openings 103 are substantially similar to the support members 12 and openings 103, respectively in FIG. 1. It is noted that the electrolyte solution 20 are omitted from FIG. 6 for conceptual clarity, but would otherwise be included as part of the capacitor 400.

The difference between the capacitor 400 and the capacitor 100 in FIG. 2 is that two opposite surfaces of each third conductive sheet 106 are arranged with the first sealing members 140 at the edges. A surface of the first conductive sheet 102 facing toward the third conductive sheets 106 is arranged with the first sealing member 140. A surface of the second conductive sheet 104 facing toward the third conductive sheet 106 is also arranged with a first sealing member 140, thereby, a height of each receiving cavity is equal to at least twice the thickness of the first sealing member 140.

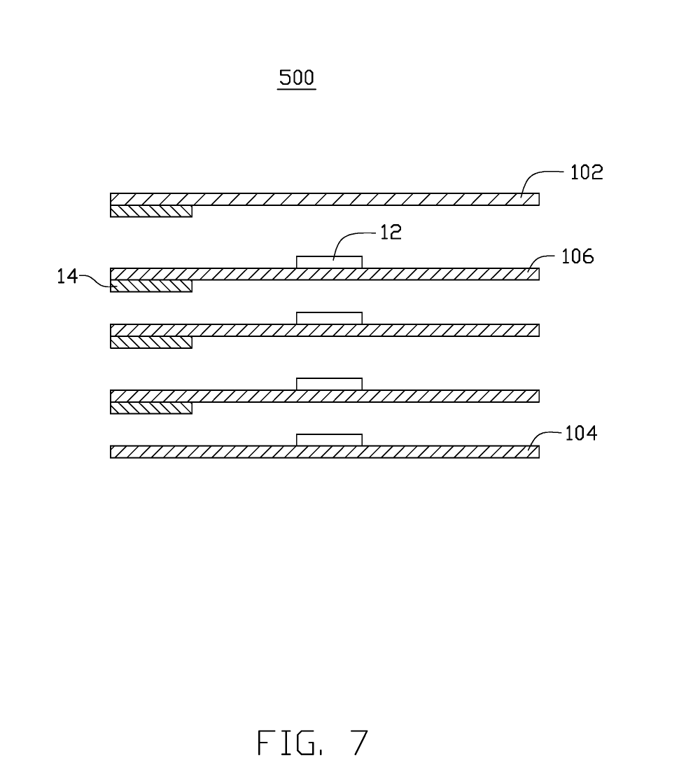

FIG. 7 illustrates a cross-sectional view of a capacitor 500 according to one embodiment. The capacitor 500 in FIG. 7 is similar to the capacitor 100 in FIG. 2. For example, with similar numerals representing similar features in FIG. 2, the capacitor 500 includes a first conductive sheet 106, a second conductive sheet 104, and a plurality of third conductive sheets 106. The first sealing members 102, second conductive sheet 104 and third conductive sheets 106 are substantially similar to the first sealing members 102, second conductive sheet 104 and third conductive sheets 106, respectively in FIG. 2. It is noted that the second sealing members 105 and electrolyte solution 20 are omitted from FIG. 7 for conceptual clarity, but would otherwise be included as part of the capacitor 500.

The difference between the capacitor 500 and the capacitor 100 in FIG. 2 is that the supporting member 12 and the first sealing member 14 are formed on different surfaces of the conductive sheets. In detail, one surface of the first conductive sheet 102 facing the third conductive sheet 106 is arranged with a first sealing member 14. One surface of the second conductive sheet 104 facing the third conductive sheet 106 is arranged with one or more support members 12.Each second conductive sheet 106 includes two opposite surfaces, and one surface of a third conductive sheet 206 toward the first conductive sheet 102 is arranged with a one or more support members 12, and the opposite surface of the third conductive sheet 206 toward the second conductive sheet 104 is arranged with a first sealing member 14.

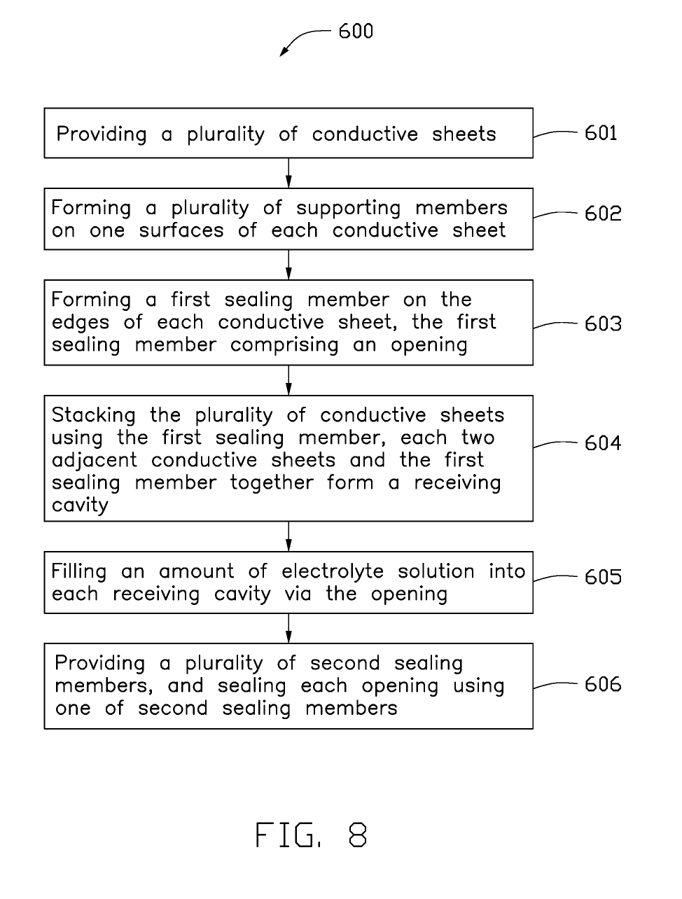

FIG. 8 illustrates a flowchart in accordance with one embodiment. The exemplary method 600 for manufacturing the capacitor 100 (shown in FIG. 1) is provided by way of example as there are a variety of ways to carry out the method. The method 600 can begin at block 601.

At block 601, with reference to FIG. 1, a plurality of conductive sheets 10 are provided. The plurality of conductive sheets 10 includes a first conductive sheet 102, a second conductive sheet 104, and a plurality of third conductive sheets 106 sandwiched between the first conductive sheet 102 and the second conductive sheet 104. The first conductive sheet 102 and the second conductive sheet 104 are the outermost layers of the capacitor 100.

At block 602, as shown in FIG. 1, a plurality of supporting elements 12 are formed on one surface of the third conductive sheet 106 and one surface of the second conductive sheet 104, the supporting elements 12 is can be cylinder-shaped, globular-shaped or ellipsoid shaped. The supporting members 12 are formed by squeezed thermosetting adhesive and cured thermosetting adhesive. The supporting members 12 formed on each conductive sheet have the same height.

At block 603, as shown in FIG. 2, a layer of thermosetting adhesive is formed at edges of the third conductive sheet 106 and edges of one surface of the second conductive sheet 104. The layer of thermosetting adhesive surround the supporting members 12, and the layer of thermosetting adhesive is cured to form the first sealing member 14. The thermosetting adhesive is substantially strip shaped and formed around a circle of the edges of the conductive sheet 10. Each layer of thermosetting adhesive includes an opening 103.

The first sealing member 14 is formed using a layer of thermosetting adhesive, and the layer of thermosetting adhesive is cured after the plurality of conductive sheets 10 are stacked. The supporting members 12 keep the stacked structure from tilting askew. And the performance of the capacitor 100 is improved.

At block 604, the plurality of conductive sheets 10 are stacked together via layers of thermosetting adhesive, and the layer of thermosetting adhesive between each two adjacent conductive sheets 10 is cured to form the first sealing member 14. The receiving cavity 101 is formed between each two adjacent conductive sheets 10.

At block 605, the stacked structure formed in block 604 is turned about 90 degrees, and an electrolyte solution 20 is filled into each receiving cavity 101 through the openings 103.

At block 606, a thermosetting adhesive (not shown) is used to fill in the opening 103 and the thermosetting adhesive is cured to form the second sealing member 105. The second sealing member 105 seals the opening 103 to avoid the electrolyte solution leakage, thereby, a capacitor 100 is obtained.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A capacitor comprising:
a plurality of conductive sheets;
a plurality of first sealing members, each first sealing member being arranged around the edges of each of the plurality of conductive sheets, and the plurality of conductive sheets being stacked with each other via the plurality of first sealing members; and each adjacent two of the plurality of conductive sheets and at least one of the plurality of first sealing members together form a receiving cavity;
an electrolyte solution filling the receiving cavity; and
a plurality of supporting members being formed in the receiving cavity to support the adjacent two of the plurality of conductive sheets.

2. The capacitor of claim 1, wherein at least one of the plurality of conductive sheets is a conductive metal sheet or a conductive ceramic sheet.

3. The capacitor of claim 1, wherein at least one of the plurality of supporting members is substantially cylinder-shaped, globular shaped or ellipsoid shaped.

4. The capacitor of claim 3, wherein the plurality of conductive sheets comprises a first conductive sheet, a second conductive sheet, and a plurality of third conductive sheets sandwiched between the first conductive sheet and the second conductive sheet, the first conductive sheet has a same shape with the second conductive sheet, the plurality of third conductive sheets have same size with each other.

5. The capacitor of claim 4, wherein the first conductive sheet comprises a first flat plate portion and a first metal electrode formed thereon, the second conductive sheet comprises a second flat plate portion and a second metal electrode formed thereon, the first flat plate portion and the second flat plate portion are arranged toward the third conductive sheets.

6. The capacitor of claim 5, wherein the first metal electrode is formed at a first side of the first plat portion, the second metal electrode is formed at a second side of the second plat portion, the first side and the second side are opposite of each other.

7. The capacitor of claim 6, wherein the first metal electrode is integrally formed with the first flat portion, the second metal electrode is integrally formed with the second flat plate portion.

8. The capacitor of claim 7, wherein each receiving cavity comprises an opening, and the capacitor further comprises a plurality of second sealing members, each of the second sealing members is configured to seal one of the openings.

9. The capacitor of claim 7, wherein the supporting member and the first sealing member are formed at opposite surfaces of each of the plurality of conductive sheets.

10. A method for manufacturing a capacitor comprising:
providing a plurality of conductive sheets;
forming a plurality of supporting members on one surfaces of each conductive sheet;
forming a first sealing member on the edges of each conductive sheet, the first sealing member comprising an opening;
stacking the plurality of conductive sheets using the first sealing member, each two adjacent conductive sheets and the first sealing member together form a receiving cavity;
filling an electrolyte solution into each receiving cavity via the opening; and
providing a plurality of second sealing members, and sealing each opening using one of the second sealing members.

11. The method of claim 10, wherein a method of providing a plurality of second sealing member comprises steps: filling a thermosetting adhesive into each opening; and curing the thermosetting adhesive to form the second sealing member.

12. The method of claim 10, wherein the supporting members are substantially cylinder-shaped.

13. The method of claim 10, wherein the supporting members are globular shaped.

14. The method of claim 10, wherein the supporting members are ellipsoid shaped.

15. The method of claim 10, wherein the plurality of conductive sheets comprises a first conductive sheet, a second conductive sheet, and a plurality of third conductive sheets sandwiched between the first conductive sheet and the second conductive sheet, the first conductive sheet has a same shape with the second conductive sheet, the plurality of third conductive sheets have same size with each other.

16. The method of claim 15, wherein the first conductive sheet comprises a first flat plate portion and a first metal electrode formed thereon, the second conductive sheet comprises a second flat plate portion and a second metal electrode formed thereon, the first flat plate portion and the second flat plate portion are arranged toward the third conductive sheets.

17. A capacitor comprising:
a plurality of conductive sheets;
a plurality of first sealing members, each first sealing member being arranged around the edges of each of the plurality of conductive sheets, and the plurality of conductive sheets being stacked with each other via the plurality of first sealing members; and each adjacent two of the plurality of conductive sheets and at least one of the plurality of first sealing members form a receiving cavity;
an electrolyte solution filling the receiving cavity; wherein the receiving cavity and the electrolyte solution received in the receiving cavity together form a capacitor monomer, and the plurality of capacitor monomers are electrically connected in series with each other.

18. The capacitor of claim 17, further comprising a plurality of supporting members being formed in the receiving cavity to support the adjacent two of the plurality of conductive sheets.

19. The capacitor of claim 18, wherein the capacitor further comprises two metal electrodes, the two electrodes are formed at two opposite surfaces of the capacitor.

20. The capacitor of claim 19, wherein thereceiving cavity comprises an opening, and the capacitor further comprises a plurality of second sealing members, each of the plurality of second sealing members is configured to seal a corresponding one of the openings.
